(19) United States
(12) Patent Application Publication
(10) Pub. No.: US 2025/0033355 A1
(43) Pub. Date: Jan. 30, 2025

(54) LIQUID EJECTING HEAD AND LIQUID EJECTING APPARATUS

(71) Applicant: SEIKO EPSON CORPORATION, Tokyo (JP)

(72) Inventors: Masaki MORI, SHIOJIRI-SHI (JP); Hitoshi TAKAAI, AZUMINO-SHI (JP)

(21) Appl. No.: 18/787,061

(22) Filed: Jul. 29, 2024

(30) Foreign Application Priority Data
Jul. 28, 2023 (JP) 2023-123134

(51) Int. Cl. B41J 2/14; B41J 2/045

(52) U.S. Cl. CPC B41J 2/14233; B41J 2/04563; B41J 2/04588; B41J 2002/14491

(57) ABSTRACT

A liquid ejecting head includes a detection resistor disposed on a lower side of the piezoelectric bodies in a direction of lamination and at a position not overlapping the individual electrodes, formed from the same material as that of the individual electrodes and the common electrode, and configured to change its resistance value in response to a temperature of the liquid inside the pressure chambers. The detection resistor includes an overlapping region overlapping the common electrode and a non-overlapping region not overlapping the common electrode at a cross-section where the pressure chamber substrate is sectioned at a position where the pressure chamber is present on a plane parallel to a longitudinal direction of the pressure chambers and the direction of lamination.

The present application is based on, and claims priority from JP Application Serial Number 2023-123134, filed Jul. 28, 2023, the disclosure of which is hereby incorporated by reference herein in its entirety.

### BACKGROUND

### 1. Technical Field

The present disclosure relates to a liquid ejecting head and a liquid ejecting apparatus.

### 2. Related Art

JP-A-2022-124599 discloses a liquid ejecting head provided with a piezoelectric element, which includes a resistor with a wire disposed in the vicinity of a pressure chamber, the resistor being designed to change its resistance value in response to a change in temperature so as to detect a temperature of a liquid in the pressure chamber.

According to the technique disclosed in JP-A-2022-124599, the resistor is disposed in a state of being covered with a piezoelectric body (see FIG. 5). In this case, the resistor is influenced by noise attributed to a drive current flowing on drive wiring for driving the piezoelectric element. A conceivable option in order to relatively reduce the influence of the noise is to restrict a range to dispose a common electrode to be laminated on the piezoelectric body so as to keep the range of provision of the common electrode from overlapping a position to dispose the resistor. Here, the common electrode provided above the piezoelectric body has a function to suppress adsorption of moisture by the piezoelectric body. From the viewpoint of suppressing adsorption of moisture, it is not desirable to restrict the range of the common electrode immoderately. Thus, there has been a demand for a technique to reduce the influence of the noise on the resistor while suppressing adsorption of moisture at the same time.

### SUMMARY

An aspect of the present disclosure provides a liquid ejecting head. This liquid ejecting head includes: a pressure chamber substrate including a pressure chamber line having a plurality of pressure chambers arranged in a first direction; a plurality of individual electrodes individually provided to the plurality of pressure chambers; piezoelectric bodies laminated on the plurality of individual electrodes, respectively, and driven in order to apply a pressure to a liquid inside the plurality of pressure chambers; a common electrode including at least one electrode provided in common to the plurality of pressure chambers and laminated on the piezoelectric bodies; and a detection resistor disposed on a lower side of the piezoelectric bodies in a direction of lamination to laminate the plurality of individual electrodes, the piezoelectric bodies, and the common electrode and at a position not overlapping the plurality of individual electrodes, formed from an identical material to a material of at least any of the plurality of individual electrodes and the common electrode, and configured to change a resistance value in response to a temperature of the liquid inside the plurality of pressure chambers, the detection resistor includes an overlapping region overlapping the common electrode and a non-overlapping region not overlapping the common electrode at a cross-section where the pressure chamber substrate is sectioned at a position where the pressure chamber is present on a plane parallel to a longitudinal direction of the plurality of pressure chambers and the direction of lamination.

### BRIEF DESCRIPTION OF THE DRAWINGS

FIG. 1 is a schematic diagram illustrating a schematic configuration of a liquid ejecting apparatus.

FIG. 2 is a block diagram illustrating a schematic configuration in light of functions of a control unit and a liquid ejecting head.

FIG. 3 is an exploded perspective view illustrating a configuration of the liquid ejecting head.

FIG. 4 is an explanatory diagram illustrating the configuration of the liquid ejecting head in plan view.

FIG. 5 is a cross-sectional view illustrating a cross-section of the liquid ejecting head taken along the V-V line in FIG. 4.

FIG. 6 is an enlarged cross-sectional view of a portion in the vicinity of a piezoelectric element in a first pressure chamber line.

FIG. 7 is a cross-sectional view illustrating a cross-section of the liquid ejecting head taken along the VII-VII line in FIG. 4.

FIG. 8 is an enlarged cross-sectional view of a portion in the vicinity of a piezoelectric element according to Other Embodiment 1.

FIG. 9 is an enlarged cross-sectional view of a portion in the vicinity of a piezoelectric element according to Other Embodiment 2.

FIG. 10 is an explanatory diagram concerning a layout of a second electrode according to Other Embodiment 3.

FIG. 11 is an explanatory diagram illustrating a configuration of a liquid ejecting head according to Other Embodiment 6 in plan view.

### DESCRIPTION OF EMBODIMENTS

### A. Embodiment

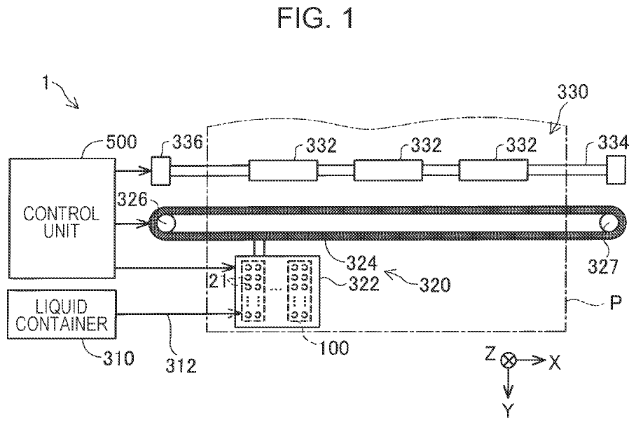

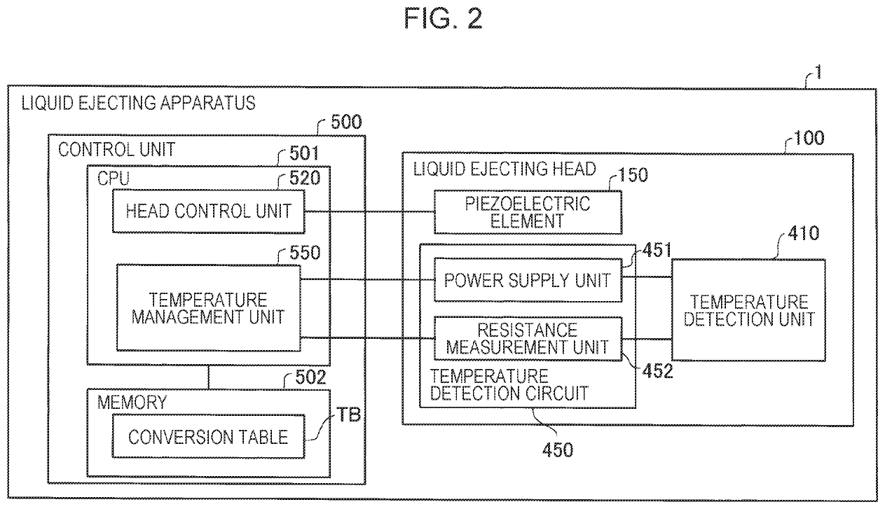

FIG. 1 is a schematic diagram illustrating a schematic configuration of a liquid ejecting apparatus 1 including a liquid ejecting head 100. An xyz orthogonal coordinate system is set up in FIG. 1 in order to facilitate understanding. X axis and y axis extend along a horizontal plane while z axis extends in a vertical direction. Note that the above-mentioned definitions do not always apply depending on a direction of placement of the liquid ejecting apparatus 1. Orthogonality includes a range from 90°±10°. The xyz orthogonal coordinate system is also set up in the drawings from FIG. 2 on likewise.

The liquid ejecting apparatus 1 is an ink jet printer which ejects an ink as an example of a liquid, thereby printing an image on printing paper P being a medium. The medium being a target of ejection of the ink from the liquid ejecting apparatus 1 is not limited only to the printing paper P, but will also be any of plastics, films, fibers, fabrics, leather, metal, glass, wood, ceramics, and so forth.

The liquid ejecting apparatus 1 includes the liquid ejecting head 100 that ejects the liquid, a liquid container 310, a head movement mechanism 320, a transportation mechanism 330, and a control unit 500.

The liquid ejecting head 100 includes nozzles 21 for ejecting the liquid, and ejects the liquid supplied from the liquid container 310 onto the printing paper P. The nozzles 21 are arranged in the y-axis direction. Details of the structure of the liquid ejecting head 100 will be described later.

The liquid container 310 stores the liquid to be ejected from the liquid ejecting head 100. The liquid stored in the liquid container 310 is supplied to the liquid ejecting head 100 through a tube 312 made of a resin. The liquid container 310 is a liquid package in the form of a bag being formed from a flexible film, for example.

The head movement mechanism 320 includes a carriage 322 that mounts the liquid ejecting head 100, a driving belt 324 to which the carriage 322 is fixed, a movement motor 326 and a pulley 327 that reciprocate the driving belt 324 in a main scanning direction. By reciprocating the driving belt 324 in the main scanning direction, the movement motor 326 reciprocates the carriage 322 and the liquid ejecting head 100 in the main scanning direction. The main scanning direction includes +x direction and −x direction. A vertical scanning direction is a direction intersecting with the main scanning direction and includes +y direction and −y direction. In the illustrated example, the liquid is ejected in +z direction from the nozzles 21.

The transportation mechanism 330 includes three transportation rollers 332, a transportation rod 334 attaching the transportation rollers 332, and a transportation motor 336. The printing paper P is transported in the vertical scanning direction by causing the transportation motor 336 to rotate the transportation rod 334.

FIG. 2 is a block diagram illustrating a schematic configuration in light of functions of the control unit 500 and the liquid ejecting head 100. The liquid ejecting head 100 includes a piezoelectric element 150, a temperature detection unit 410, and a temperature detection circuit 450. A detailed configuration of the liquid ejecting head 100 will be described later. Here, the temperature detection circuit 450 may be provided outside the liquid ejecting head 100.

The piezoelectric element 150 is a driving element for applying a pressure to the liquid in the after-mentioned pressure chamber of the liquid ejecting head 100.

The temperature detection unit 410 is formed from resistance wiring used for temperature detection. In the present specification, the resistance wiring used for detecting the temperature will be referred to as a detection resistor. Details of the temperature detection unit 410 will be described later.

The temperature detection circuit 450 estimates the temperature of the liquid in the pressure chamber by using a characteristic of an electric resistance value of the resistance wiring made of a metal, a semiconductor, and the like, which varies with the temperature.

The temperature detection circuit 450 includes a power supply unit 451 and a resistance measurement unit 452. The power supply unit 451 is a constant-current circuit, for example. The power supply unit 451 feeds a constant current to the temperature detection unit 410 in accordance with control by a temperature management unit 550. The resistance measurement unit 452 acquires a resistance value of the detection resistor of the temperature detection unit 410 based on a current value of the constant current fed from the power supply unit 451 to the temperature detection unit 410, and voltage values at two ends of the detection resistor included in the temperature detection unit 410. The resistance measurement unit 452 outputs the acquired resistance value of the detection resistor of the temperature detection unit 410 to the temperature management unit 550. The resistance measurement unit 452 will also be referred to as a “resistance value acquisition unit”.

The control unit 500 controls the entire liquid ejecting apparatus 1. The control unit 500 is a microcomputer that includes a central processing unit (CPU) 501 and a memory 502. Various programs to be executed by the CPU 501 are stored in the memory 502. Meanwhile, a conversion table TB to be described later is stored in the memory 502. The CPU 501 executes the programs stored in the memory 502, thus functioning as a head control unit 520 and the temperature management unit 550. Here, the control unit 500 may be realized by one or more processing circuits of a field programmable gate array (FPGA), an application specific integrated circuit (ASIC), and the like instead of the CPU.

The head control unit 520 controls a reciprocating operation of the carriage 322 along the main scanning direction and a transporting operation of the printing paper P along the vertical scanning direction. Moreover, the head control unit 520 controls ejection of the liquid onto the printing paper P by driving the piezoelectric element 150. In the present embodiment, the head control unit 520 determines a drive waveform for driving the piezoelectric element 150 based on the temperature of the liquid in the pressure chamber acquired from the temperature management unit 550, and drives the piezoelectric element 150 with a drive signal having the determined drive waveform. Accordingly, it is possible to drive the piezoelectric element 150 in accordance with the temperature of the liquid in the pressure chamber. The head control unit 520 will also be referred to as a “drive waveform determination unit”.

The temperature management unit 550 acquires a temperature in the vicinity of the pressure chamber by using the resistance value of the detection resistor of the temperature detection unit 410 acquired from the resistance measurement unit 452 and using the conversion table TB. In the present embodiment, the temperature of the liquid in the pressure chamber can be detected by using the temperature in the vicinity of the pressure chamber thus acquired. For example, the acquired temperature in the vicinity of the pressure chamber may be treated as the temperature of the liquid in the pressure chamber. Alternatively, a value derived from the acquired temperature in the vicinity of the pressure chamber in accordance with a predetermined method may be treated as the temperature of the liquid in the pressure chamber. The conversion table TB includes information that represents a correspondence relation between the electric resistance value of the detection resistor and the temperature. The temperature management unit 550 outputs the acquired temperature of the liquid in the pressure chamber to the head control unit 520. Here, the temperature management unit 550 may compute the temperature of the liquid in the pressure chamber by using the resistance value of the detection resistor of the temperature detection unit 410 and a temperature computation formula that is stored in a storage unit 584 in advance. The temperature management unit 550 will also be referred to as a “temperature acquisition unit”.

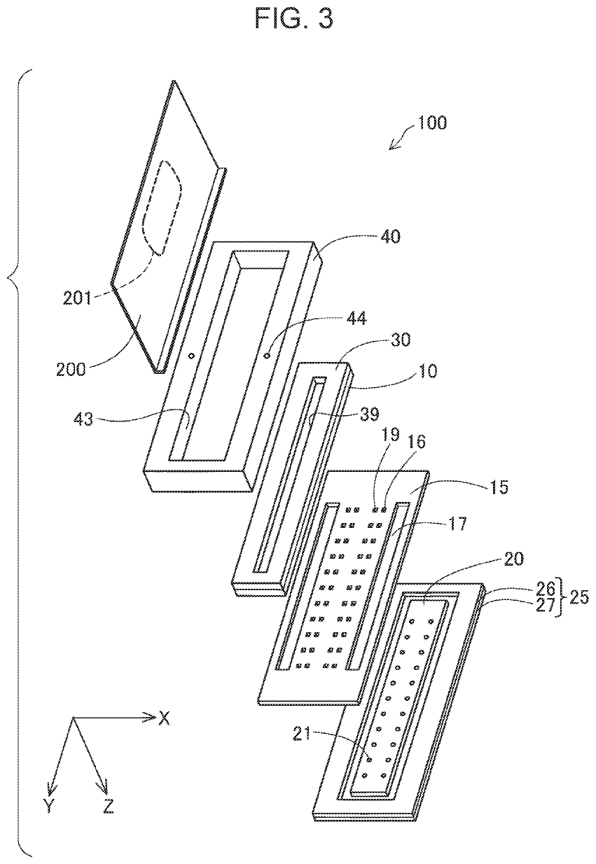

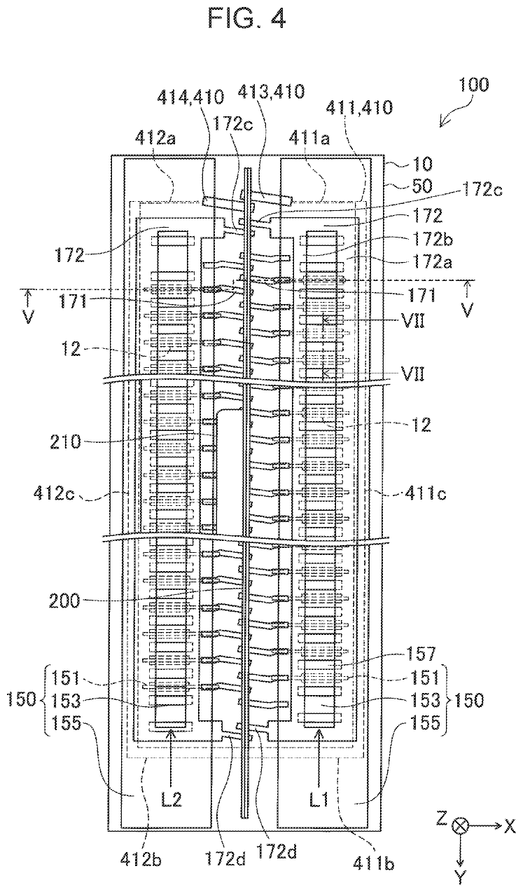

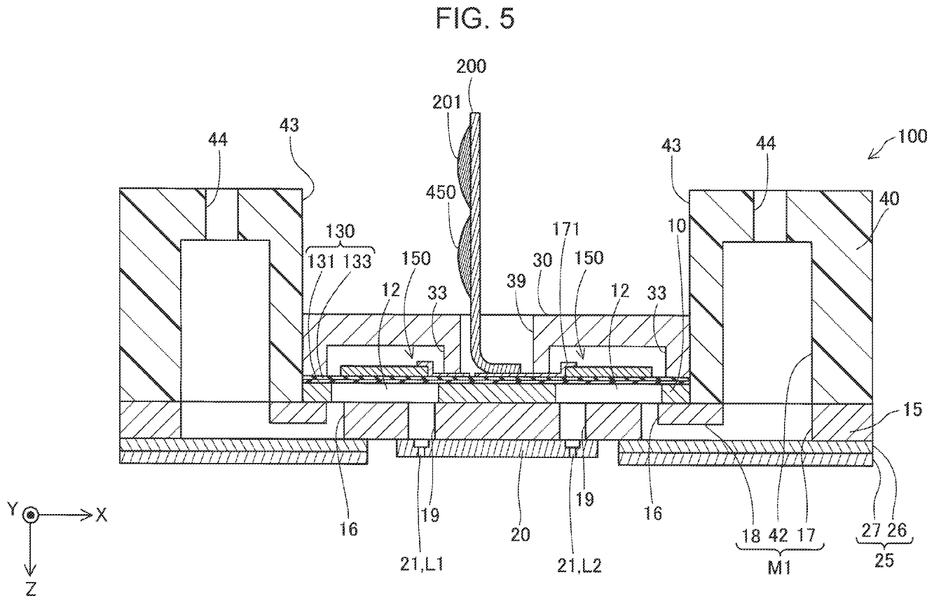

The detailed configuration of the liquid ejecting head 100 will be described with reference to FIGS. 3 to 5. FIG. 3 is an exploded perspective view illustrating the configuration of the liquid ejecting head 100. FIG. 4 is an explanatory diagram illustrating the configuration of the liquid ejecting head 100 in plan view. In the present specification, the “plan view” means a state of viewing an object in a direction of lamination. FIG. 5 is a cross-sectional view illustrating a cross-section of the liquid ejecting head 100 taken along the V-V line in FIG. 4.

As illustrated in FIG. 3, the liquid ejecting head 100 includes a pressure chamber substrate 10, a communication substrate 15, a nozzle substrate 20, a compliance substrate 25, a protection substrate 30, a case member 40, a vibration plate 130, piezoelectric elements 150, individual electrodes 171, a common electrode 172, wires 175, a wiring board 200, the temperature detection unit 410, and the temperature detection circuit 450. Note that FIG. 3 omits illustration of the vibration plate 130 (see FIG. 5), the piezoelectric elements 150 (see FIG. 5), the temperature detection unit 410 (see FIG. 4), and the temperature detection circuit 450 (see FIG. 5).

The pressure chamber substrate 10, the communication substrate 15, the nozzle substrate 20, the compliance substrate 25, the protection substrate 30, the case member 40, the vibration plate 130, and the piezoelectric elements 150 are lamination members. The liquid ejecting head 100 is formed by laminating these lamination members. A direction to laminate the lamination members constituting the liquid ejecting head 100 will also be referred to as a “direction of lamination”. In the present embodiment, the direction of lamination coincides with the z-axis direction. With respect to a predetermined reference position, +z direction side will also be referred to as a “lower side” while −z direction side will also be referred to as an “upper side”.

The pressure chamber substrate 10 is formed from a single-crystal silicon substrate. Alternatively, the pressure chamber substrate 10 may be formed from a metal material such as stainless steel (SUS) and a nickel (Ni), a ceramic material such as zirconia (Zro₂) and alumina (Al₂O₃), a glass ceramic material, or an oxide material such as magnesium oxide (MgO) and lanthanum aluminate (LaAlO₃).

As illustrated in FIG. 4, the pressure chamber substrate 10 is provided with pressure chambers 12. Each pressure chamber 12 is a space for applying a pressure to the liquid. In the example illustrated in FIG. 4, the pressure chamber substrate 10 is provided with a first pressure chamber line L1 including pressure chambers 12 arranged in the y-axis direction, and a second pressure chamber line L2 including pressure chambers 12 arranged in the y-axis direction. A direction (the y-axis direction) of arrangement of the pressure chambers 12 will be referred to as a direction of arrangement. The first pressure chamber line L1 and the second pressure chamber line L2 are disposed in such a way as to be arranged in a direction (the x-axis direction) intersecting with the direction of arrangement. The pressure chambers 12 that belong to the first pressure chamber line L1 and the pressure chambers 12 that belong to the second pressure chamber line L2 are disposed in such a way as to be located in a staggered fashion in the direction of arrangement (the y-axis direction). The direction of arrangement of the pressure chambers 12 will also be referred to as a “first direction”.

As illustrated in FIG. 3, the communication substrate 15 is disposed on a lower side of the pressure chamber substrate 10. The communication substrate 15 is fixed to a surface on the lower side of the pressure chamber substrate 10 by using an adhesive. The communication substrate 15 is formed from a single-crystal silicon substrate, for example.

As illustrated in FIG. 5, the communication substrate 15 is provided with ink supply channels 16, first common liquid chambers 17, second common liquid chambers 18, and nozzle communication ports 19. Each ink supply channel 16 is a through hole that penetrates the communication substrate 15 in the z-axis direction. The ink supply channel 16 is formed in the pressure chamber substrate 10 and couples the pressure chamber 12 to the second common liquid chamber 18. The ink supply channel 16 is a flow channel that introduces the liquid into the pressure chamber 12. Each first common liquid chamber 17 is formed as a through hole that penetrates the communication substrate 15 in the z-axis direction. Each second common liquid chamber 18 is formed as a recess provided on a lower surface (a surface on the −z side) of the communication substrate 15. The second common liquid chamber 18 couples the ink supply channel 16 to the first common liquid chamber 17. The first common liquid chamber 17 and the second common liquid chamber 18 form a manifold M1 constituting a common liquid chamber in conjunction with a liquid chamber unit 42 provided to the case member 40 to be described later. Each nozzle communication port 19 is a through hole that penetrates the communication substrate 15 in the z-axis direction. The nozzle communication port 19 couples the pressure chamber 12 to the nozzle 21. The nozzle communication port 19 is a flow channel that discharges the liquid from the pressure chamber 12. The communication substrate 15 is provided with the nozzle communication ports 19 in the number corresponding to the number of the nozzles 21.

As illustrated in FIG. 3, the nozzle substrate 20 and the compliance substrate 25 are disposed on the lower side of the communication substrate 15. The nozzle substrate 20 and the compliance substrate 25 are fixed to a surface on the lower side of the communication substrate 15 by using an adhesive. The nozzle substrate 20 is formed from a single-crystal silicon substrate, for example. The nozzle substrate 20 is provided with the nozzles 21.

The compliance substrate 25 is disposed around the nozzle substrate 20. As illustrated in FIG. 5, the compliance substrate 25 covers respective openings of the first common liquid chambers 17 and the second common liquid chambers 18 provided to the communication substrate 15. The compliance substrate 25 includes a sealing film 26 formed from a flexible thin film, and a fixation substrate 27 formed from a hard material such as a metal.

As illustrated in FIG. 5, the protection substrate 30 is disposed on an upper side of the pressure chamber substrate 10 while interposing the vibration plate 130 therebetween. The protection substrate 30 is fixed to a surface on the upper side of the vibration plate 130 by using an adhesive. The vibration plate 130 disposed between the pressure chamber substrate 10 and the protection substrate 30 will be described later. A material constituting the protection substrate 30 is the same as that of the pressure chamber substrate 10.

The protection substrate 30 is provided in order to protect the piezoelectric element 150 and to increase strength of the pressure chamber substrate 10 and the vibration plate 130. The protection substrate 30 is provided with recesses 33 and a through hole 39. Each recess 33 is a recess that is open on the +z side. The recess 33 is not coupled to the flow channel for the liquid. For this reason, the liquid does not circulate in the recesses 33. The through hole 39 is a through hole that penetrates the protection substrate 30 in the z-axis direction. The wiring board 200 is inserted into the through hole 39.

As illustrated in FIG. 3, the case member 40 is disposed on the upper side of the communication substrate 15. The case member 40 is formed from a resin material, for example.

As illustrated in FIG. 5, the case member 40 includes the liquid chamber unit 42, a coupling port 43, and two liquid communication ports 44. As described earlier, the liquid chamber unit 42 forms the manifold M1 constituting the common liquid chamber in conjunction with the first common liquid chamber 17 and the second common liquid chamber 18 provided to the communication substrate 15. The coupling port 43 is a through hole that penetrates the case member 40 in the z-axis direction. The protection substrate 30 is fitted into the coupling port 43. Each liquid communication port 44 is a through hole that penetrates the case member 40 in the z-axis direction. The liquid flows from the liquid communication port 44 into the liquid ejecting head 100.

The vibration plate 130 is laminated on the upper side of the pressure chamber substrate 10 at a position overlapping the pressure chambers 12 when viewed in the direction of lamination. The vibration plate 130 includes a flexible layer 131 and a protection layer 133. The flexible layer 131 is formed on the pressure chamber substrate 10. The flexible layer 131 is formed from silicon dioxide (SiO₂), for example. The protection layer 133 is formed on the flexible layer 131. The protection layer 133 is an insulating film formed from zirconium oxide (ZrO₂), for example.

The piezoelectric elements 150 are disposed on the upper side of the pressure chamber substrate 10 together with the vibration plate 130. To be more precise, each piezoelectric element 150 is disposed above the vibration plate 130 inside the recess 33 provided to the protection substrate 30. The piezoelectric element 150 vibrates the vibration plate 130, thereby applying the pressure to the liquid in the pressure chamber 12. When the pressure is applied to the liquid in the pressure chamber 12, the liquid is ejected from the nozzle 21 through the nozzle communication port 19.

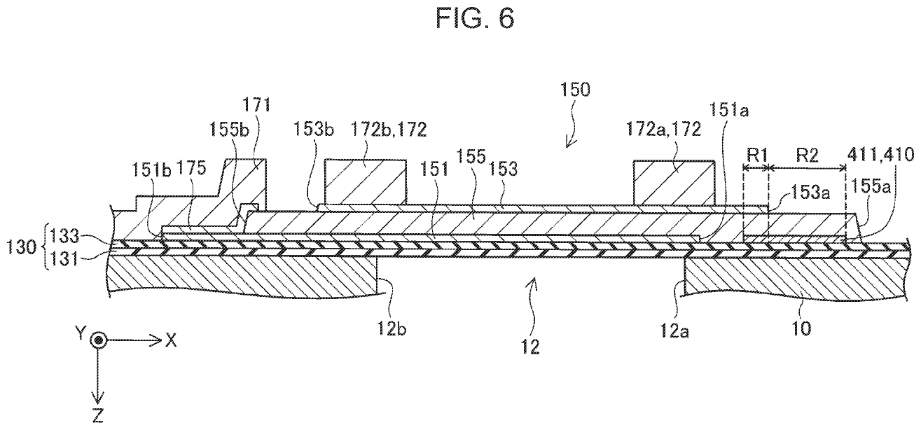

FIG. 6 is an enlarged cross-sectional view of a portion in the vicinity of one of the piezoelectric elements 150 in the first pressure chamber line L1. While the piezoelectric element 150 in the first pressure chamber line L1 will be described below as an example, it is to be noted that the second pressure chamber line L2 has the same configuration. The piezoelectric element 150 includes a first electrode 151, a second electrode 153, and a piezoelectric body 155. The first electrode 151, the piezoelectric body 155, and the second electrode 153 are laminated in this order in the direction of lamination.

The first electrode 151 is an individual electrode to be individually provided to each of the pressure chambers 12. The first electrode 151 is formed from a conductive material such as gold (Au), platinum (Pt), iridium (Ir), titanium (Ti), and tungsten (W). The first electrode 151 is disposed at such a position that overlaps the corresponding pressure chamber 12 on the surface on the upper side of the vibration plate 130 when viewed in the direction of lamination. As illustrated in FIG. 4, a width of the first electrode 151 is smaller than a width in a lateral direction (the y-axis direction) of the pressure chamber 12.

As illustrated in FIG. 6, an end portion 151a on the +x side of the first electrode 151 is located on an outer side (the +x side) relative to an end portion 12a on the +x side of the pressure chamber 12. An end portion 151b on the −x side of the first electrode 151 is located on an outer side (the −x side) relative to an end portion 12b on the −x side of the pressure chamber 12. In other words, a length of the first electrode 151 is larger than a length in a longitudinal direction (the x direction) of the pressure chamber 12.

The piezoelectric body 155 is disposed in such a way as to extend in the direction of arrangement (the y-axis direction) of the pressure chambers 12. The piezoelectric body 155 is formed from a lead zirconate titanate (PZT), for example. Instead, the piezoelectric body 155 may be formed from a different material such as potassium sodium diniobate and barium titanate. The piezoelectric body 155 is formed in a thickness in a range from 1000 nm to 4000 nm, for example.

As illustrated in FIG. 6, an end portion 155a on the +x side of the piezoelectric body 155 is located on an outer side (the +x side) relative to the end portion 12a on the +x side of the pressure chamber 12. An end portion 155b on the −x side of the piezoelectric body 155 is located on an outer side (the −x side) relative to the end portion 12b on the −x side of the pressure chamber 12. In other words, a length of the piezoelectric body 155 is larger than the length in the longitudinal direction (the x direction) of the pressure chamber 12. Since the piezoelectric body 155 extends to the outside of the pressure chamber 12 in the longitudinal direction as described above, the strength of the vibration plate 130 is improved.

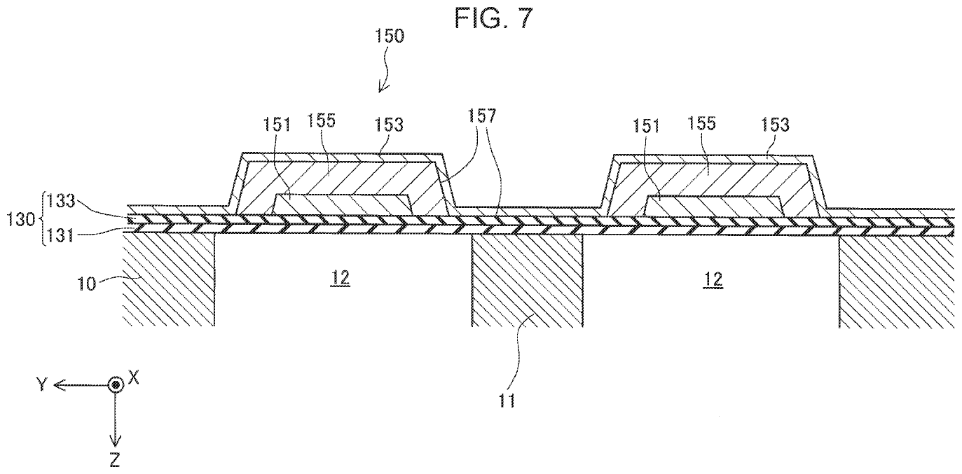

FIG. 7 is a cross-sectional view taken along the VII-VII line in FIG. 4. A groove portion 157 is formed between two adjacent piezoelectric bodies 155. As illustrated in FIG. 4, the groove portion 157 takes on a rectangular shape when viewed in the direction of lamination. As illustrated in FIG. 7, the groove portion 157 is provided at a position corresponding to each partition wall 11. The partition wall 11 is a wall portion that separates two adjacent pressure chambers 12. A width of the groove portion 157 in the y-axis direction is set equal to or above a width of the partition wall 11. The groove portion 157 is formed by providing a layer of the piezoelectric body 155 on the vibration plate 130 and the first electrode 151, and then removing the piezoelectric body 155 in an appropriate region.

Each second electrode 153 is a common electrode to be provided to the pressure chambers 12 in common. As illustrated in FIG. 4, the second electrode 153 is disposed in such a way as to extend in the direction of arrangement (the y-axis direction) of the pressure chambers 12. The second electrode 153 is disposed across a range overlapping all the pressure chambers 12 that belong to the pressure chamber line for each of the first pressure chamber line L1 and the second pressure chamber line L2. The second electrode 153 may be formed from the same material as that of the first electrode 151 or may be formed from a different material therefrom. As illustrated in FIG. 7, the second electrode 153 is also provided on a side surface of the groove portion 157 of the piezoelectric body 155 and on the protection layer 133 being a bottom surface of the groove portion 157. In the present embodiment, the second electrode 153 is provided to each of the first pressure chamber line L1 and the second pressure chamber line L2. Thus, it is possible to prevent consumption of unnecessary electric power when driving only one of the first pressure chamber line L1 and the second pressure chamber line L2.

The first electrodes 151 and the second electrodes 153 are electrically coupled to a driving circuit 201 provided to the wiring board 200 (see FIG. 5). The drive signal is applied to each first electrode 151. The drive signal varies depending on an amount of ejection of the liquid. In the present embodiment, a waveform of the drive signal varies depending on the temperature of the liquid in the pressure chamber 12. A reference voltage signal is applied to each second electrode 153. The reference voltage signal is constant irrespective of the amount of ejection of the liquid. The amount of ejection of the liquid is an amount of change in volume required by the pressure chamber 12. The piezoelectric body 155 is deformed when a difference in potential is generated between the first electrode 151 and the second electrode 153. Due to the deformation of the piezoelectric body 155, the vibration plate 130 is vibrated so as to change the volume of the pressure chamber 12. The pressure is applied to the liquid contained in the pressure chamber 12 as a consequence of the change in volume of the pressure chamber 12, and the liquid is ejected from the nozzle 21 through the nozzle communication port 19.

As illustrated in FIGS. 4 and 6, the individual electrodes 171 and the common electrode 172 to be described later function as drive wiring for applying a voltage for driving the piezoelectric bodies 155 to the piezoelectric bodies 155. Each individual electrode 171 couples the first electrode 151 to the wiring board 200. The wire 175 couples the individual electrode 171 to the first electrode 151 in the vicinity of the end portion 151b on the −x side of the first electrode 151. Accordingly, the first electrode 151 being the individual electrode is electrically coupled to the wiring board 200.

As illustrated in FIG. 4, in each of the first pressure chamber line L1 and the second pressure chamber line L2, the common electrode 172 couples the second electrode 153 being the corresponding common electrode to the wiring board 200. The common electrode 172 includes an extending portion 172a, an extending portion 172b, a coupling portion 172c, and a coupling portion 172d.

As illustrated in FIGS. 4 and 6, the extending portion 172a extends in the lateral direction (the y-axis direction) of the pressure chamber 12 at the position corresponding to the end portion 12a on the +x side of the pressure chamber 12. The extending portion 172b extends in the lateral direction (the y-axis direction) of the pressure chamber 12 at the position corresponding to the end portion 12b on the −x side of the pressure chamber 12.

The coupling portion 172c is a portion disposed in the vicinity of an end portion on the −y side of the extending portion 172b and extends from the extending portion 172b toward the wiring board 200. The coupling portion 172c extends in a direction having a predetermined inclination with respect to the x axis. For example, the coupling portion 172c extends in an axial direction in a case of turning the x axis clockwise at 20 degrees within the xy plane. An end portion of the coupling portion 172c is coupled to the wiring board 200. Accordingly, an end portion of the second electrode 153 being the common electrode is electrically coupled to the wiring board 200.

The coupling portion 172d is a portion disposed in the vicinity of an end portion on the +y side of the extending portion 172b and extends from the extending portion 172b toward the wiring board 200. The coupling portion 172d extends in the same direction as the coupling portion 172c. An end portion of the coupling portion 172d is coupled to the wiring board 200. Accordingly, another end portion of the second electrode 153 being the common electrode is electrically coupled to the wiring board 200.

As illustrated in FIG. 5, the individual electrodes 171 and the common electrode 172 are disposed in such a way as to be partially exposed to the inside of the through hole 39 formed in the protection substrate 30. The individual electrodes 171 and the common electrode 172 are electrically coupled to the wiring board 200 in the through hole 39.

The individual electrodes 171 and the common electrode 172 are formed from a conductive material such as gold (Au), copper (Cu), titanium (Ti), tungsten (W), nickel (Ni), chromium (Cr), platinum (Pt), and aluminum (Al). The individual electrodes 171 and the common electrode 172 are formed on the same layer. However, the individual electrodes 171 are not electrically coupled to the common electrode 172. Thus, it is possible to simplify a manufacturing process and to reduce costs as compared to a case of forming the individual electrodes 171 and the common electrode 172 on different layers.

The wiring board 200 is formed from a flexible printed circuit (FPC) board, for example.

As illustrated in FIG. 5, the wiring board 200 is provided with the driving circuit 201 and the temperature detection circuit 450 to be described later. The driving circuit 201 generates the drive signal for driving the piezoelectric elements 150 based on a control signal supplied from the head control unit 520 of the control unit 500.

As illustrated in FIG. 4, the temperature detection unit 410 includes a first detection resistor 411, a second detection resistor 412, a first detection lead electrode 413, and a second detection lead electrode 414. The resistance measurement unit 452 acquires a resistance value of combined resistance of these components.

As illustrated in FIG. 4, the first detection resistor 411 includes a first portion 411a, a second portion 411b, and a third portion 411c. The first portion 411a is a portion that extends in the longitudinal direction (the x-axis direction) of the pressure chambers 12 in the vicinity of the first pressure chamber line L1. The second portion 411b is a portion that is located on an opposite side of the side where the first portion 411a is disposed with respect to the first pressure chamber line L1, and extends in the longitudinal direction of the pressure chambers 12 in the vicinity of the first pressure chamber line L1. The third portion 411c is a portion that extends in the direction of arrangement (the y-axis direction) without being bent in the vicinity of the first pressure chamber line L1, and joins the first portion 411a to the second portion 411b. Thus, the first detection resistor 411 is disposed in such a way as to surround the first pressure chamber line L1. The vicinity of the first pressure chamber line L1 means a position where a distance from each of the first portion 411a, the second portion 411b, and the third portion 411c to the first pressure chamber line L1 falls within a predetermined distance and a resistance value of the first detection resistor 411 varies with the temperature of the liquid inside the pressure chambers 12 of the first pressure chamber line L1. As described above, the first detection resistor 411 is disposed at the position where the resistance value varies with the temperature of the liquid inside the pressure chambers 12 of the first pressure chamber line L1.

As with the first detection resistor 411, the second detection resistor 412 includes a first portion 412a, a second portion 412b, and a third portion 412c. The second detection resistor 412 is disposed in such a way as to surround the second pressure chamber line L2 in the vicinity of the second pressure chamber line L2. The vicinity of the second pressure chamber line L2 means a position where a distance from each of the first portion 412a, the second portion 412b, and the third portion 412c to the second pressure chamber line L2 falls within a predetermined distance and a resistance value of the second detection resistor 412 varies with the temperature of the liquid inside the pressure chambers 12 of the second pressure chamber line L2. As described above, the second detection resistor 412 is disposed at the position where the resistance value varies with the temperature of the liquid inside the pressure chambers 12 of the second pressure chamber line L2.

An end portion on the −x side of the second portion 411b of the first detection resistor 411 is coupled to an end portion on the +x side of the second portion 412b of the second detection resistor 412 in the vicinity of end portions on the −y side of first pressure chamber line L1 and the second pressure chamber line L2. Accordingly, the first detection resistor 411 and the second detection resistor 412 collectively constitute a line of resistance wiring.

The first detection lead electrode 413 couples an end portion of the first portion 411a of the first detection resistor 411 to the wiring board 200 in the vicinity of the end portion on the −y side of the first pressure chamber line L1. The second detection lead electrode 414 couples an end portion of the first portion 412a of the second detection resistor 412 to the wiring board 200 in the vicinity of the end portion on the −y side of the second pressure chamber line L2. Accordingly, one end and the other end of the line of resistance wiring formed from the first detection resistor 411 and the second detection resistor 412 are electrically coupled to the wiring board 200.

The first detection lead electrode 413 and the second detection lead electrode 414 are disposed on the same layer as the individual electrodes 171 and the common electrode 172 in the direction of lamination. The first detection lead electrode 413 and the second detection lead electrode 414 are formed from the same material as that of the individual electrodes 171 and the common electrode 172. The first detection lead electrode 413 and the second detection lead electrode 414 are formed together with the individual electrodes 171 and the common electrode 172 in the process of forming the individual electrodes 171 and the common electrode 172. However, the first detection lead electrode 413 and the second detection lead electrode 414 are not electrically coupled to the individual electrodes 171 and the common electrode 172. It is possible to simplify a manufacturing process and to reduce costs as compared to a case of forming the first detection lead electrode 413 and the second detection lead electrode 414 on a different layer from the layer on which the individual electrodes 171 and the common electrode 172 are formed.

As illustrated in FIG. 6, the first detection resistor 411 is provided on a surface on the −z side of the vibration plate 130. To be more precise, the first detection resistor 411 is disposed between the vibration plate 130 and the piezoelectric body 155 in the direction of lamination (the z-axis direction) and is covered with the piezoelectric body 155. The same applies to the second detection resistor 412.

The first detection resistor 411 and the second detection resistor 412 are disposed on the same layer as the first electrode 151 in the direction of lamination. The first detection resistor 411 and the second detection resistor 412 are formed from the same material as that of the first electrode 151. As with the first electrode 151, the first detection resistor 411 and the second detection resistor 412 are formed from a material such as gold (Au), platinum (Pt), iridium (Ir), titanium (Ti), and tungsten (W). Each of these materials is a material having conductivity with its electric resistance value exhibiting a temperature dependency at the same time.

The first detection resistor 411 and the second detection resistor 412 are formed together with the first electrode 151 in a process of forming the first electrode 151. However, the first detection resistor 411 and the second detection resistor 412 are not electrically coupled to the first electrode 151. Thus, it is possible to simplify a manufacturing process and to reduce costs as compared to a case of forming the first detection resistor 411 and the second detection resistor 412 on a different layer from the first electrode 151.

Next, characteristic configurations of the present embodiment will be described. While the first detection resistor 411 will be described below as an example, the second detection resistor 412 also has the same configuration.

A certain region of the first detection resistor 411 overlaps the second electrode 153 being the common electrode. Meanwhile, another certain region of the first detection resistor 411 does not overlap the second electrode 153. In the example illustrated in FIG. 6, the region overlapping the second electrode 153 is illustrated as a first region R1 while the region not overlapping the second electrode 153 is illustrated as a second region R2. The first region R1 will also be referred to as an “overlapping region”. The second region R2 will also be referred to as a “non-overlapping region”. As illustrated in FIG. 4, within a range where the first detection resistor 411 is disposed in the direction of arrangement (the y-axis direction), the certain region of the first detection resistor 411 overlaps the second electrode 153 while the other certain region of the first detection resistor 411 does not overlap the second electrode 153. Meanwhile, within a range where the first detection resistor 411 is disposed in the longitudinal direction (the x-axis direction) of the pressure chambers 12, the first detection resistor 411 is disposed in such a way as not to overlap the second electrode 153.

It is possible to reduce the influence of the noise on the first detection resistor 411 while suppressing adsorption of moisture by disposing the first detection resistor 411 as described above. Thus, temperature detection accuracy can be improved.

As illustrated in FIG. 6, a length of the first region R1 is smaller than a length of the second region R2 in the longitudinal direction (the x-axis direction) of the pressure chambers 12. Accordingly, it is possible to reduce the influence of the noise on the first detection resistor 411 as compared to an aspect in which the length of the first region R1 is larger than the length of the second region R2 in the longitudinal direction.

Meanwhile, the second region R2 is located at a farther position from the pressure chambers 12 than the first region R1 is in the longitudinal direction (the x direction) of the pressure chambers 12, because the influence of adsorption of moisture on the piezoelectric body 155 is less at the position away from the pressure chambers 12 even when the second electrode 153 is not disposed above the piezoelectric body 155.

In the meantime, as illustrated in FIGS. 4 and 6, a width in the x-axis direction of the first detection resistor 411 is increased in a range of extension in the y-axis direction. Thus, it is possible to widen the cross-sectional area of the first detection resistor 411. The same applies to the second detection resistor 412. Thus, it is possible to reduce the resistance values of the first detection resistor 411 and the second detection resistor 412.

Moreover, since the first detection resistor 411 is disposed without bending the first detection resistor 411, a wiring length of the first detection resistor 411 is shorter as compared to the aspect of bending the first detection resistor 411. The same applies to the second detection resistor 412. Thus, the resistance values of the first detection resistor 411 and the second detection resistor 412 are reduced as compared to the aspect of bending the first detection resistor 411. As the resistance of the first detection resistor 411 and the second detection resistor 412 is reduced, the values of the currents flowing on the first detection resistor 411 and the second detection resistor 412 become larger. When the second electrode 153 overlaps the entire ranges of the first detection resistor 411 and the second detection resistor 412 as in the related art, not only a drive current for the piezoelectric elements 150 brings about noise to the currents flowing on the first detection resistor 411 and the second detection resistor 412, but also the currents flowing on the first detection resistor 411 and the second detection resistor 412 bring about noise to the drive current for the piezoelectric elements 150.

However, in the present embodiment, the first detection resistor 411 is disposed such that the certain region thereof overlaps the second electrode 153 serving as the common electrode while the other certain region thereof does not overlap the second electrode 153. The same applies to the second detection resistor 412. By disposing the first detection resistor 411 and the second detection resistor 412 as described above, it is possible to reduce the influence of the noise attributed to the drive current for the piezoelectric elements 150 on the first detection resistor 411 and the second detection resistor 412 as compared to the aspect in which the first detection resistor 411 and the second detection resistor 412 do not include any regions not overlapping the second electrode 153 serving as the common electrode.

### B. Other Embodiments

### B1. Other Embodiment 1

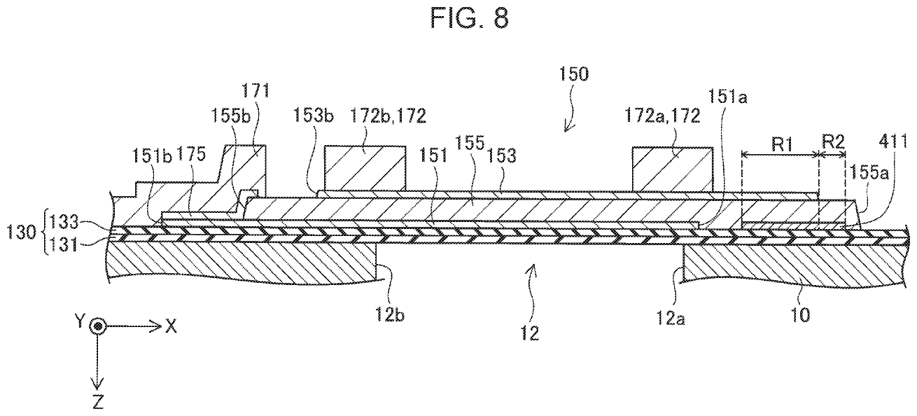

FIG. 8 is an enlarged cross-sectional view of a portion in the vicinity of the piezoelectric element 150 in the first pressure chamber line L1 according to Other Embodiment 1. The following description will be focused on different configurations from those in the Embodiment. Explanations of the same configurations as those in the Embodiment will be omitted. In the Other Embodiment 1, the length of the first region R1 is set larger than the length of the second region R2 in the longitudinal direction (the x-axis direction) of the pressure chambers 12. In the longitudinal direction, the range of coverage of the piezoelectric body 155 by the second electrode 153 is wider than that in the aspect where the length of the first region R1 is smaller than the length of the second region R2. Accordingly, it is possible to suppress adsorption of moisture more appropriately.

Moreover, as with the Embodiment, it is possible to reduce the influence of the noise on the first detection resistor 411 as compared to the aspect in which the first detection resistor 411 does not include the range not overlapping the second electrode 153.

### B2: Other Embodiment 2

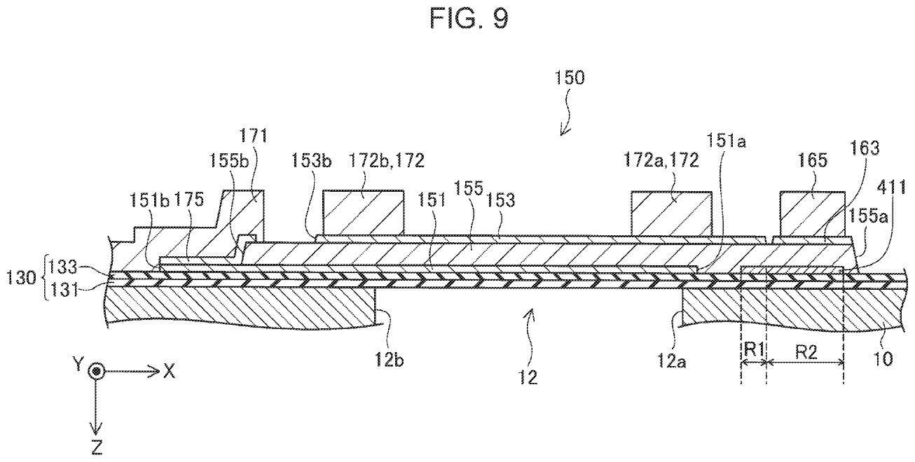

FIG. 9 is an enlarged cross-sectional view of a portion in the vicinity of the piezoelectric element 150 in the first pressure chamber line L1 according to Other Embodiment 2. The following description will be focused on different configurations from those in the Embodiment. Explanations of the same configurations as those in the Embodiment will be omitted.

In the Other Embodiment 2, a first non-electrode layer 163 is provided on an upper side (the −z side) of the piezoelectric body 155 in a range overlapping the second region R2 being the non-overlapping region. Moreover, a second non-electrode layer 165 is provided on an upper side of the first non-electrode layer 163. Each of the first non-electrode layer 163 and the second non-electrode layer 165 will also be referred to as a “non-electrode layer”.

The first non-electrode layer 163 and the second electrode 153 are formed on the same layer. However, the first non-electrode layer 163 is not electrically coupled to the second electrode 153. The material constituting the first non-electrode layer 163 is the same as that of the second electrode 153. The first non-electrode layer 163 is formed together with the second electrode 153 in the process of forming the second electrode 153. It is possible to simplify a manufacturing process and to reduce costs as compared to a case of forming the first non-electrode layer 163 and the second electrode 153 on different layers.

The second non-electrode layer 165 is formed on the same layer as the individual electrodes 171 and the common electrode 172. However, the second non-electrode layer 165 is not electrically coupled to the individual electrodes 171 and the common electrode 172. The material constituting the second non-electrode layer 165 is the same as that of the individual electrodes 171 and the common electrode 172. The second non-electrode layer 165 is formed together with the common electrode 172 in the process of forming the common electrode 172. It is possible to simplify a manufacturing process and to reduce costs as compared to a case of forming the second non-electrode layer 165 and the common electrode 172 on different layers.

Provision of the first non-electrode layer 163 and the second non-electrode layer 165 makes it possible to match a thickness of the layer in the range of lamination of the second electrode 153 and the common electrode 172 with a thickness of the layer in the range of the second region R2 being the non-overlapping region. It is preferable to set the thickness of the layer in the range where the second electrode 153 and the common electrode 172 are laminated equal to the thickness of the layer in the range of the second region R2 being the non-overlapping region. For example, there may be a case of disposing a plate-like sealing member on the common electrode 172. Here, it is easy to dispose the sealing member by providing the first non-electrode layer 163 and the second non-electrode layer 165.

### B3: Other Embodiment 3

The Embodiment has described the example in which lengths in the longitudinal direction of the respective pressure chambers 12 in the first region R1 and the second region R2 are constant as illustrated in FIG. 6.

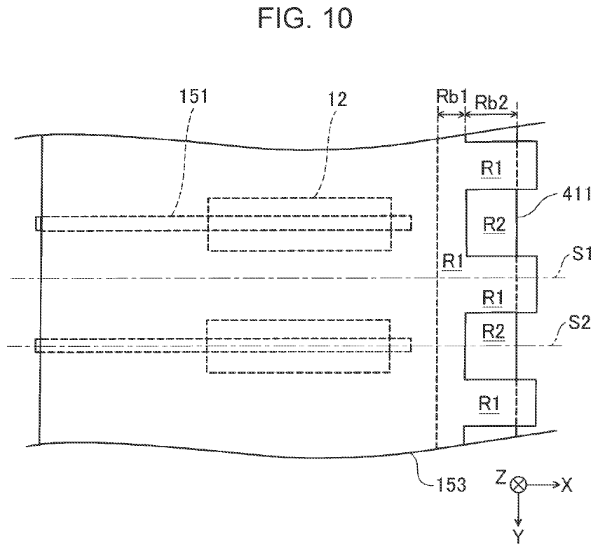

FIG. 10 is an explanatory diagram concerning a layout of the second electrode 153 according to Other Embodiment 3. In the example illustrated in FIG. 10, the range set as the first region R1 in the Embodiment is illustrated as a range Rb1 while the range set as the second region R2 therein is illustrated as a range Rb2. In the Other Embodiment 3, the first detection resistor 411 overlaps the second electrode 153 in the range Rb1. In other words, the range Rb1 is set up as the first region R1. In the range Rb2, the second electrode 153 is provided with notches in a rectangular shape in the lateral direction (the y-axis direction) of the pressure chambers 12. As a consequence, the regions where the first detection resistor 411 overlaps the second electrode 153 and the regions where the first detection resistor 411 does not overlap the second electrode 153 are alternately disposed in the lateral direction (the y-axis direction) of the pressure chambers 12. In other words, in the range Rb2, the first regions R1 and the second regions R2 are alternately set up in the lateral direction of the pressure chambers 12.

In the range Rb2, a position on the y axis where the second region R2 is set up corresponds to the position of each pressure chamber 12 on the y axis. The pressure chambers 12 are arranged in the y-axis direction with predetermined intervals in between. As a consequence, the second regions R2 and the first regions R1 are alternately disposed in the range Rb2. For this reason, the first detection resistor 411 does not include the second region R2 on a cross-section where the pressure chamber substrate 10 is sectioned at a position indicated with a cross-sectional line S1 and at a position where the pressure chamber 12 is not present on the plane parallel to the longitudinal direction of the pressure chamber 12 and the direction of lamination. Meanwhile, the first detection resistor 411 includes the second region R2 on a cross-section where the pressure chamber substrate 10 is sectioned at a position indicated with a cross-sectional line S2 and at a position where the pressure chamber 12 is not present on the plane parallel to the longitudinal direction of the pressure chamber 12 and the direction of lamination.

In the range where the first electrode 151 being the individual electrode does not overlap the first detection resistor 411, the first detection resistor 411 is not influenced by the noise even when the first detection resistor 411 overlaps the second electrode 153 being the common electrode. Accordingly, it is possible to suppress adsorption of moisture efficiently by disposing the second electrode 153 above the piezoelectric body 155 within such a range that does not have the influence of the noise.

### B4: Other Embodiment 4

Meanwhile, a single common electrode corresponding to both the first pressure chamber line L1 and the second pressure chamber line L2 may be provided instead of individually providing the second electrodes 153 to the first pressure chamber line L1 and the second pressure chamber line L2. In other words, the two second electrodes 153 in FIG. 4 may be configured to be joined to each other.

### B5. Other Embodiment 5

The Embodiment has described the example in which the individual electrodes 171, the coupling portions 172c, and the coupling portions 172d extend in the same direction (see FIG. 4). Instead, a layout of the individual electrodes 171, the coupling portions 172c, and the coupling portions 172d may be different from that illustrated in FIG. 4.

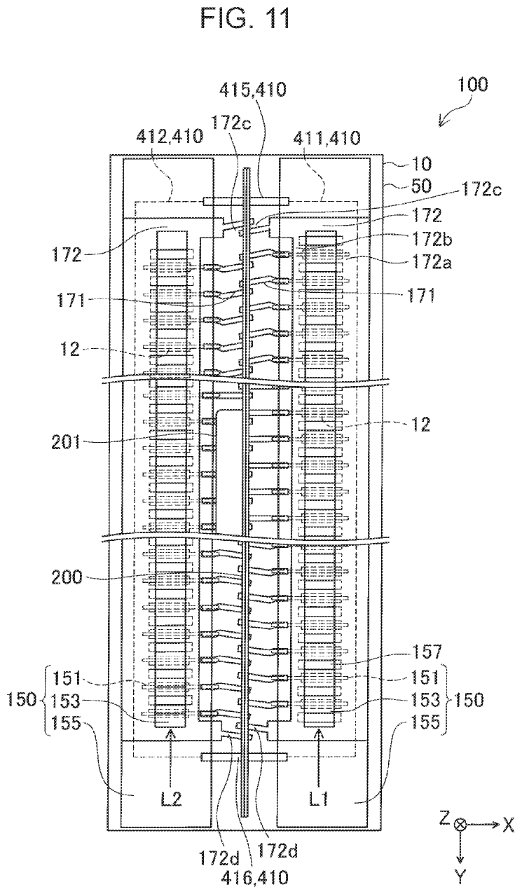

FIG. 11 is an explanatory diagram illustrating another configuration of the liquid ejecting head 100 in plan view. In the example illustrated in FIG. 11, at the end portion on the +y side and at the end portion on the −y side of the pressure chamber substrate 10, the individual electrodes 171, the coupling portions 172c, and the coupling portions 172d extend in directions having predetermined inclinations with respect to the x axis. To be more precise, at the end portion on the +y side of the pressure chamber substrate 10, the individual electrodes 171 and the coupling portions 172d extend in an axial direction in the case of turning the x axis clockwise by 20 degrees within the xy plane. At the end portion on the −y side of the pressure chamber substrate 10, the individual electrodes 171 and the coupling portions 172c extend in an axial direction in the case of turning the x axis counterclockwise by 20 degrees within the xy plane. At a central part in the y-axis direction of the pressure chamber substrate 10, the individual electrodes 171 extend in the x-axis direction.

The present disclosure is not limited to the above-described embodiments and can be realized by various configurations within a range not departing from the gist of the present disclosure. For example, the technical features in the embodiments corresponding to technical features in respective aspects described in the chapter of the summary of the present disclosure may be exchanged or combined as appropriate in order to solve all or part of the above-mentioned problems or to realize all or part of the above-mentioned advantageous effects. Meanwhile, the technical features therein may be deleted as appropriate as long as the relevant technical features are not described as indispensable features in the present specification.

### C. Other Aspects

(1) An aspect of the present disclosure provides a liquid ejecting head. This liquid ejecting head includes: a pressure chamber substrate including a pressure chamber line having a plurality of pressure chambers arranged in a first direction; a plurality of individual electrodes individually provided to the plurality of pressure chambers; piezoelectric bodies laminated on the plurality of individual electrodes, respectively, and driven in order to apply a pressure to a liquid inside the plurality of pressure chambers; a common electrode including at least one electrode provided in common to the plurality of pressure chambers and laminated on the piezoelectric bodies; and a detection resistor disposed on a lower side of the piezoelectric bodies in a direction of lamination to laminate the plurality of individual electrodes, the piezoelectric bodies, and the common electrode and at a position not overlapping the plurality of individual electrodes, formed from an identical material to a material of at least any of the plurality of individual electrodes and the common electrode, and configured to change a resistance value in response to a temperature of the liquid inside the plurality of pressure chambers, the detection resistor includes an overlapping region overlapping the common electrode and a non-overlapping region not overlapping the common electrode at a cross-section where the pressure chamber substrate is sectioned at a position where the pressure chamber is present on a plane parallel to a longitudinal direction of the plurality of pressure chambers and the direction of lamination.

According to this aspect, it is possible to reduce the influence of the noise on the detection resistor as compared to an aspect in which the detection resistor does not include a range not overlapping the common electrode.

(2) In the liquid ejecting head according to above aspect, the overlapping region may be located at position closer to the pressure chambers in the longitudinal direction than the non-overlapping region is.
the influence of adsorption of moisture on the piezoelectric body is less at the position away from the pressure chambers, even when the common electrode is not disposed above the piezoelectric body, the non-overlapping region is located at position away from the pressure chambers.

(3) In the liquid ejecting head according to above aspect, a length in the longitudinal direction of the overlapping region may be larger than a length in the longitudinal direction of the non-overlapping region.

According to this aspect, the overlapping region is longer than the non-overlapping region in the longitudinal direction. Thus, it is possible to suppress adsorption of moisture as compared to an aspect in which the overlapping region is shorter than the non-overlapping region in the longitudinal direction.

(4) In the liquid ejecting head according to above aspect, a length in the longitudinal direction of the overlapping region may be smaller than a length in the longitudinal direction of the non-overlapping region.

According to this aspect, the overlapping region is shorter than the non-overlapping region in the longitudinal direction. Thus, it is possible to reduce the influence of the noise on the resistor as compared to the aspect in which the overlapping region is longer than the non-overlapping region in the longitudinal direction.

(5) In the liquid ejecting head according to above aspect, a non-electrode layer formed from an identical material to the material of the common electrode and not electrically coupled to the common electrode may be provided on an upper side in the direction of lamination of the piezoelectric bodies in a region overlapping the non-overlapping region.

According to this aspect, provision of the non-electrode layer makes it possible to match a thickness of the layer in the range where the detection resistor is disposed with a thickness of the layer in the range where the common electrode is laminated.

(6) In the liquid ejecting head according to above aspect, a thickness of a layer in a range where the non-electrode layer is provided may be equal to a thickness of a layer in a range where the common electrode is provided.

According to this aspect, provision of the non-electrode layer makes it possible to match a thickness of the layer in the range of the non-overlapping region with the thickness of the layer in the range where the common electrode is laminated.

(7) In the liquid ejecting head according to above aspect, the detection resistor may not include the non-overlapping region at a cross-section where the pressure chamber substrate is sectioned at a position where the pressure chamber is not present on the plane parallel to the longitudinal direction of the pressure chambers and the direction of lamination.

According to this aspect, the individual electrode does not overlap the detection resistor. Hence, the detection resistor is not influenced by the noise even when there is the region where the detection resistor overlaps the common electrode. As a consequence, the common electrode for suppressing adsorption of moisture can be disposed on the piezoelectric body within the range where there is no influence of the noise.

(8) In the liquid ejecting head according to above aspect, the liquid ejecting head may further include: a wiring board, the detection resistor may include a first portion extending in the longitudinal direction near the pressure chamber line, with one end portion of the first portion being coupled to the wiring board, a second portion being located on an opposite side of a side where the first portion is disposed with respect to the pressure chamber line, extending in the longitudinal direction near the pressure chamber line, with one end portion of the second portion being coupled to the wiring board, and a third portion extending in the first direction without being bent near the pressure chamber line, and joining another end of the first portion to another end of the second portion.

(9) Another aspect of the present disclosure provides a liquid ejecting apparatus. This liquid ejecting apparatus includes: the liquid ejecting head according to above aspect; a resistance value acquisition unit that acquires a resistance value of the detection resistor; and a temperature acquisition unit that acquires a temperature near the pressure chambers based on the resistance value acquired by the resistance value acquisition unit.

According to this aspect, it is possible to reduce the influence of the noise and to improve temperature detection accuracy.

(10) In the liquid ejecting apparatus according to above aspect, the liquid ejecting apparatus may further include: a drive waveform determination unit that determines a drive waveform to be applied to the plurality of individual electrodes based on the temperature acquired by the temperature acquisition unit.

According to this aspect, it is possible to drive the piezoelectric element in accordance with the temperature.

The present disclosure can be realized not only in the above-described aspect as the liquid ejecting apparatus, but also in various aspects including a liquid ejecting system, a multifunction machine including a liquid ejecting apparatus, and so forth.

What is claimed is:

1. A liquid ejecting head comprising:
a pressure chamber substrate including a pressure chamber line having a plurality of pressure chambers arranged in a first direction;
a plurality of individual electrodes individually provided to the plurality of pressure chambers;
piezoelectric bodies laminated on the plurality of individual electrodes, respectively, and driven in order to apply a pressure to a liquid inside the plurality of pressure chambers;
a common electrode including at least one electrode provided in common to the plurality of pressure chambers and laminated on the piezoelectric bodies; and
a detection resistor disposed on a lower side of the piezoelectric bodies in a direction of lamination to laminate the plurality of individual electrodes, the piezoelectric bodies, and the common electrode and at a position not overlapping the plurality of individual electrodes, formed from an identical material to a material of at least any of the plurality of individual electrodes and the common electrode, and configured to change a resistance value in response to a temperature of the liquid inside the plurality of pressure chambers, wherein
the detection resistor includes an overlapping region overlapping the common electrode and a non-overlapping region not overlapping the common electrode at a cross-section where the pressure chamber substrate is sectioned at a position where the pressure chamber is present on a plane parallel to a longitudinal direction of the plurality of pressure chambers and the direction of lamination.

2. The liquid ejecting head according to claim 1, wherein the overlapping region is located at position closer to the pressure chambers in the longitudinal direction than the non-overlapping region is.

3. The liquid ejecting head according to claim 1, wherein a length in the longitudinal direction of the overlapping region is larger than a length in the longitudinal direction of the non-overlapping region.

4. The liquid ejecting head according to claim 1, wherein a length in the longitudinal direction of the overlapping region is smaller than a length in the longitudinal direction of the non-overlapping region.

5. The liquid ejecting head according to claim 1, wherein a non-electrode layer formed from an identical material to the material of the common electrode and not electrically coupled to the common electrode is provided on an upper side in the direction of lamination of the piezoelectric bodies in a region overlapping the non-overlapping region.

6. The liquid ejecting head according to claim 5, wherein a thickness of a layer in a range where the non-electrode layer is provided is equal to a thickness of a layer in a range where the common electrode is provided.

7. The liquid ejecting head according to claim 1, wherein the detection resistor does not include the non-overlapping region at a cross-section where the pressure chamber substrate is sectioned at a position where the pressure chamber is not present on the plane parallel to the longitudinal direction of the pressure chambers and the direction of lamination.

8. The liquid ejecting head according to claim 1, further comprising:
a wiring board, wherein
the detection resistor includes
a first portion extending in the longitudinal direction near the pressure chamber line, with one end portion of the first portion being coupled to the wiring board,
a second portion being located on an opposite side of a side where the first portion is disposed with respect to the pressure chamber line, extending in the longitudinal direction near the pressure chamber line, with one end portion of the second portion being coupled to the wiring board, and
a third portion extending in the first direction without being bent near the pressure chamber line, and joining another end of the first portion to another end of the second portion.

9. A liquid ejecting apparatus comprising:
the liquid ejecting head according to claim 1;
a resistance value acquisition unit that acquires a resistance value of the detection resistor; and
a temperature acquisition unit that acquires a temperature near the pressure chambers based on the resistance value acquired by the resistance value acquisition unit.

10. The liquid ejecting apparatus according to claim 9, further comprising:
a drive waveform determination unit that determines a drive waveform to be applied to the plurality of individual electrodes based on the temperature acquired by the temperature acquisition unit.
